(19) United States
(12) Patent Application Publication
(10) Pub. No.: US 2014/0223788 A1
(43) Pub. Date: Aug. 14, 2014

(54) Protective sleeve for a signpost

(71) Applicant: Rosalee Price, Champaign, IL (US)

(72) Inventor: Rosalee Price, Champaign, IL (US)

(21) Appl. No.: 14/173,601

(22) Filed: Feb. 5, 2014

Related U.S. Application Data
(60) Provisional application No. 61/763,550, filed on Feb. 12, 2013.

(51) Int. Cl. G09F 7/18

(52) U.S. Cl. CPC G09F 7/18
USPC 40/607.05

(57) ABSTRACT

A rubber or leather sleeve conforms to the signpost of a small yard sign, and prevents it from damaging or soiling a vehicle interior. In addition, a scraping tool is stored in a pocket on the interior or exterior of the sleeve and retained there by a fastener, for example a grommet. The scraping tool is used to remove excess debris, such as dirt, snow, and mud from the sign before placing it inside the sleeve for transport.

### CROSS-REFERENCE TO RELATED APPLICATIONS

This application claims priority to U.S. Provisional Application No. 61/763,550, filed Feb. 12, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to protective coverings and in particular to a protective sleeve for signposts. When transferring small, portable yard signs between locations in their cars, both real estate agents and political campaign workers frequently soil and damage the upholstery and carpeting in their vehicles. When the signposts are pulled out of the ground, they transfer dirt, snow, and mud onto the vehicles they are being transported in, and easily scratch the upholstery. Real estate agents in particular often transport clients in their vehicle and thus require a clean and tidy interior to maintain their professional image. A small, easily attached sign sleeve, with an attached scraper, would protect the interior of the vehicles transporting the signposts from being damaged or soiled by the signposts. A scraper attached to the signpost sleeve would be convenient to remove excess debris, such as dirt, snow, and mud from the signposts before they are transferred into a vehicle. The sleeve can then be quickly removed at the sign's new location.

### SUMMARY OF THE INVENTION

Accordingly, the invention is directed to a protective sleeve with attached scraper for a signpost. A rubber or leather sleeve conforms to the signpost of a small yard sign, and prevents it from damaging or soiling a vehicle interior. In addition, a scraping tool is stored in a pocket on the interior or exterior of the sleeve and retained there by a fastener, for example a grommet. The scraping tool is used to remove excess debris, such as dirt, snow, and mud from the sign before placing it inside the sleeve for transport.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows the front angular view of the first exemplary embodiment in use, with the scraping tool 12 stowed and the signpost in the sleeve 10; the pocket 11, the grommet 13, the signpost 101, the closed end 103, and the open end 104 are also displayed.

FIG. 2 shows the front angular view of the first exemplary embodiment in use, with the scraping tool 12 removed for use and the signpost in the sleeve 10, displaying the, the pocket 11, the grommet 13, the signpost 101, the closed end 103, and the open end 104 are also displayed.

FIG. 3 shows the front angular view of the first exemplary embodiment with scraping tool stowed and the signpost removed from the sleeve, displaying the protective sleeve 10, the pocket 11, the grommet 13, the scraping tool 12, the signpost 101, the signpost hole 102, the closed end 103, and the open end 104.

FIG. 4 shows the front angular view of the first exemplary embodiment with scraping tool removed for use and the signpost removed from the sleeve, displaying the protective sleeve 10, the pocket 11, the grommet 13, the scraping tool 12, the signpost 101, the signpost hole 102, the closed end 103, and the open end 104.

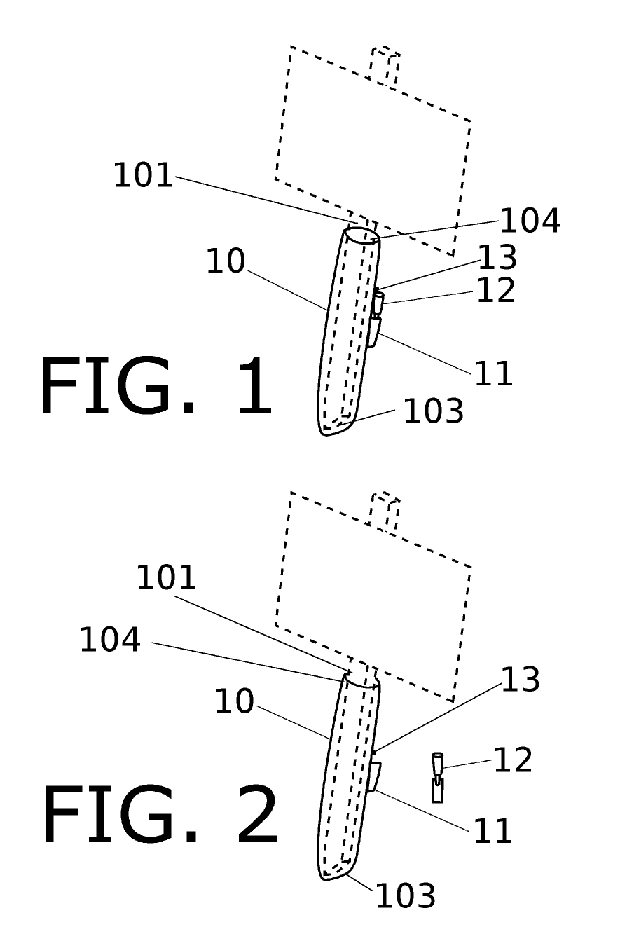

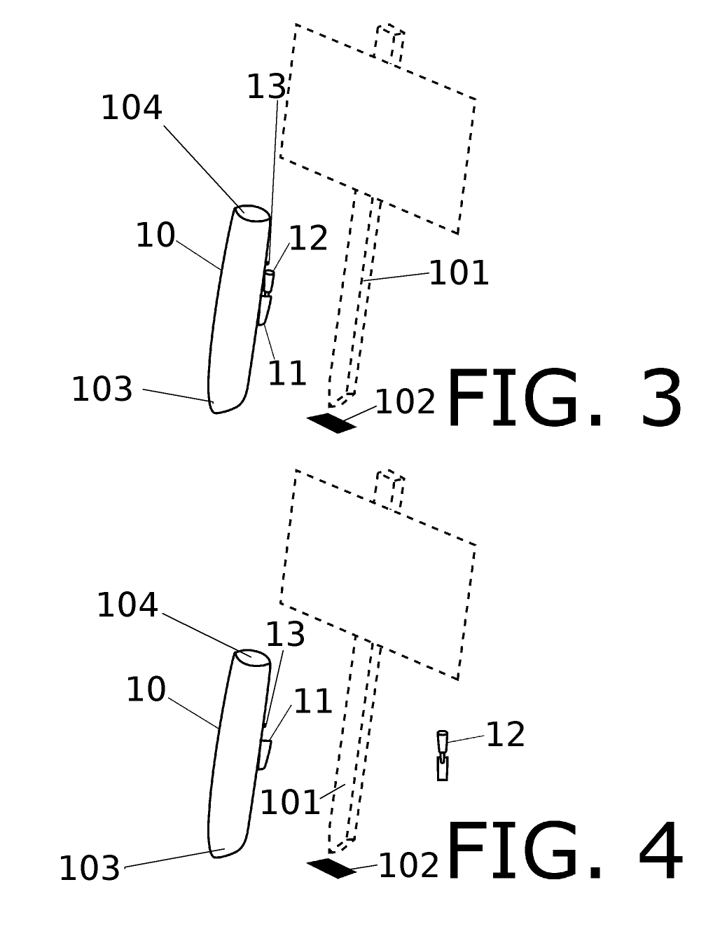

### DETAILED DESCRIPTION OF THE INVENTION

Referring now to the invention in more detail, the invention is directed to a protective sleeve for a signpost. The invention provides a sleeve 10 composed of leather, rubber, or similar materials, which conforms to the shape of the signpost 101 of a small yard sign, and prevents it from damaging or soiling a vehicle interior during storage or transportation of the sign in the vehicle. In addition, a scraping tool 12 is stored in a pocket 11 on the interior or exterior of the sleeve 10 and retained there by a fastener, for example a grommet, stud, loop of material, etc. The scraping tool 12 is used to remove excess debris, such as dirt, snow, and mud from the signpost 101 before placing it inside the sleeve for transport or storage. The sleeve 10 would be elongated and have one open end 104 and one closed end 103. The end of the signpost 101, after being removed from a signpost hole 102 and cleaned with the scraping tool 12 if necessary, would be inserted into the open end 103 of the sleeve 10 until it comes into contact with the interior surface of the closed end 104.

The sleeve 10 and its pocket 11 would be provided in various sizes to accommodate the signposts of assorted real estate and political yard signs. The sleeve 10 and its pocket 11 would be manufactured from a flexible, durable, easily cleaned material such as rubber, leather, plastic, canvas or similar materials. The scraping tool 12 would be manufactured from a rigid, durable material such as steel, aluminum, or high-impact plastic. Where a sign having two or more stakes is contemplated, the invention may be provided in a kit having multiple copies at a size appropriate for each stake of the intended multi-stake sign.

Component sizes and materials listed above are preferable, but artisans will recognize that larger or smaller components, or different materials, could be selected without altering the scope of the invention. The device would be manufactured from a rigid, heat resistant material such as bamboo, teakwood or injection molded plastic.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A protective sleeve kit for a signpost comprising:
(a) at least one sleeve;
(b) at least one signpost;
(c) said at least one sleeve being elongated in shape;
(d) said at least one sleeve having one open end and one closed end;
(e) said at least one sleeve conforming to the shape of said at least one signpost such that said at least one signpost may be inserted snugly into said at least one sleeve;
(f) at least one of said at least one sleeve having a pocket affixed thereto;
(g) a scraping tool;
(h) said pocket being shaped to accommodate said scraping tool;
(i) a retaining means for retaining said scraping tool within said pocket; and
(j) said retaining means for retaining said scraping tool within said pocket being affixed to said sleeve near the opening of said pocket.

2. The protective sleeve kit of claim 1 wherein said at least one sleeve and said pocket are made of leather.

3. The protective sleeve kit of claim 1 wherein said at least one sleeve and said pocket are made of rubber.

4. A method of using the protective sleeve kit of claim 1 comprising removing said at least one signpost from a corresponding signpost hole; if said at least one signpost is soiled, removing said scraping tool from said pocket and scraping off excess soiling material from said at least one signpost using said scraping tool, and replacing said scraping tool in said pocket; inserting said at least one signpost into said open end of said at least one sleeve, sliding said at least one signpost into said at least one sleeve until said at least one signpost contacts said closed end of said at least one sleeve, and transporting said signpost with said at least one sleeve attached, whereby a vehicle in which said at least one signpost with said at least one sleeve attached is transported will not be soiled.

5. The method of claim 4 wherein said at least one sleeve and said pocket are made of leather.

6. The method of claim 5 wherein said at least one sleeve and said pocket are made of rubber.

7. The protective sleeve kit of claim 1 wherein said at least one signpost and said at least one sleeve are one in number.

8. The protective sleeve kit of claim 2 wherein said at least one signpost and said at least one sleeve are one in number.

9. The protective sleeve kit of claim 3 wherein said at least one signpost and said at least one sleeve are one in number.

10. The method of claim 4 wherein said at least one signpost and said at least one sleeve are one in number.

11. The method of claim 5 wherein said at least one signpost and said at least one sleeve are one in number.

12. The method of claim 6 wherein said at least one signpost and said at least one sleeve are one in number.

13. The protective sleeve kit of claim 1 wherein said at least one signpost and said at least one sleeve are two in number.

14. The protective sleeve kit of claim 2 wherein said at least one signpost and said at least one sleeve are two in number.

15. The protective sleeve kit of claim 3 wherein said at least one signpost and said at least one sleeve are two in number.

16. The method of claim 4 wherein said at least one signpost and said at least one sleeve are two in number.

17. The method of claim 5 wherein said at least one signpost and said at least one sleeve are two in number.

18. The method of claim 6 wherein said at least one signpost and said at least one sleeve are two in number.
